(19) United States
(12) Patent Application Publication
(10) Pub. No.: US 2005/0208806 A1
(43) Pub. Date: Sep. 22, 2005

(54) Installation and withdrawal apparatus for plug-in modules

(75) Inventors: Kari Oila, Zurich (CH); Georg Heussi, Jona (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ELMA Electronic AG, Wetzikon (CH)

(21) Appl. No.: 11/084,127

(22) Filed: Mar. 17, 2005

(30) Foreign Application Priority Data
Mar. 19, 2004 (EP) 04405169.6
Jul. 29, 2004 (EP) 04405483.1

(51) Int. Cl. H01R 13/62

(52) U.S. Cl. 439/160

(57) ABSTRACT

An installation and withdrawal apparatus for the plugging in and pulling out of a plug-in module into or out of a module holder includes an installation and withdrawal handle (2) and a guide element (3) about which the installation and withdrawal handle (2) is rotatable and at which the installation and withdrawal handle (2) is additionally displaceably guided in a direction perpendicular to the axis of rotation.

The invention relates to an installation and withdrawal apparatus for the insertion and removal of a plug-in module into or out of a module holder in accordance with the preamble of claim 1, to an installation and withdrawal handle for use in such a plug-in module, to a plug-in module having such an installation and withdrawal apparatus and to a module holder having such a plug-in module.

Plug-in modules introducible into module holders have multiple plug connections on the rear side whose plug-in and removal forces have to be overcome on the plugging in or removal of the plug-in module. Plug-in modules are usually provided with a lower and/or an upper installation and withdrawal handle at the front side in order to facilitate the plugging in and the removal. The installation and withdrawal handles are arranged rotatably and are supported at a structure of the module holder at the front side such that the installation and withdrawal handles act as levers on the plugging in and removal. The installation and withdrawal handles must be fully outwardly pivoted for the insertion of a plug-in module as they otherwise impede the insertion of the plug-in module into the module holder or make it absolutely impossible. The position of the installation and removal handles can change unintentionally on a direct contact or on a more powerful movement of the plug-in module without appropriate precautions. In particular the upper installation and withdrawal handle tends to tilt downwardly due to gravity so that it has to be held tight on the insertion of the plug-in module. Efforts are currently being made to introduce narrow-shaped, elongate installation and withdrawal handles to the market which can be manufactured in a favorably-priced manner. The problem arises with such installation and withdrawal handles of unintended inward pivoting to a special degree.

The installation and withdrawal handles known from the prior art are usually provided with a holding apparatus to hold and/or to latch the installation and withdrawal handles in the inwardly pivoted position and to prevent an unintentional outward pivoting of the installation and withdrawal handle. With a completely inserted plug-in module, the installation and withdrawal handle is in the inwardly pivoted position such that the holding apparatus usually also serves to secure the plug-in module in the inserted state.

A plug-in module is known from document DE 203 11 072 U1 in which a blocking lever is hinged to a lever pulling handle and locks the lever pulling handle in the outwardly pivoted position and blocks it against unintended pivoting. The blocking lever furthermore includes a latching catch in order to fix the lever pulling handle in the inwardly pivoted position. The design described in DE 203 11 072 U1 with a separate blocking lever is relatively complex. The lever pulling handle can also only be inwardly pivoted by simultaneously actuating the blocking lever, which complicates the operation.

It is the object of the invention to provide an installation and withdrawal apparatus for the plugging in and removing of a plug-in module in or out of a module holder which is protected both against unintended inward pivoting and unintended outward pivoting, has a simple operation and can be manufactured economically favorably in comparison with installation and withdrawal apparatuses of the prior art. A further object of the invention consists of providing an installation and withdrawal handle for such an insertion and withdrawal apparatus, a plug-in module having such an installation and withdrawal apparatus and a module holder having such a plug-in module.

This object is satisfied in accordance with the invention by the installation and withdrawal apparatus defined in claim 1 and by the installation and withdrawal handle defined in claim 8, by the plug-in module defined in claim 13 and by the assembly carrier defined in claim 14.

The installation and withdrawal apparatus in accordance with the invention for the plugging in and pulling out of a plug-in module into or out of a module holder includes an installation and withdrawal handle and at least one guide element about which the installation and withdrawal handle can be rotated, preferably such that the direction of the axis of rotation is kept constant by the guide element. The installation and withdrawal handle is additionally displaceable in one direction, preferably in a direction perpendicular to the direction of the axis of rotation.

In a preferred embodiment, the installation and withdrawal handle is displaceable, preferably displaceably guided, in its longitudinal direction. The guide element is preferably made as a fitted collar screw with a shoulder or as a screw with a sleeve.

In a further preferred embodiment, the installation and withdrawal apparatus additionally includes a holding apparatus having at least one holding element in order to hold the installation and withdrawal handle in the outwardly pivoted state in a position suitable for the insertion of the plug-in module and/or to hold the installation and withdrawal handle in the inwardly pivoted state in a latched in position. The holding element is preferably made as a spring which is operatively engaged with the installation and withdrawal handle such that the spring is active in the direction of rotation and/or in the direction of displacement. A design of the holding elements as a pivot spring is advantageous.

In a preferred embodiment variant, the holding element is arranged in the region of the guide element, preferably at or on the guide element.

In a further preferred embodiment variant, a switch element for an active/passive switching of the plug-in module is provided which can be actuated by means of the installation and withdrawal handle, in particular by means of a projection formed at the installation and withdrawal handle.

The invention furthermore includes an installation and withdrawal handle for use in an installation and withdrawal apparatus in accordance with the description above, in which installation and withdrawal handle a guide structure, in particular a guide opening, is formed such that the installation and withdrawal handle is both rotatable about a guide element and displaceable thereat, preferably in that the guide element engages into the guide opening. The guide structure is preferably elongate in shape and made, for example, as an elongate hole.

The installation and withdrawal handle is made in one piece in a preferred embodiment.

In a further preferred embodiment, the installation and withdrawal handle can be latched in a front plate in the inwardly pivoted state by displacement, preferably by displacement in its longitudinal direction and/or in a direction perpendicular direction of the axis of rotation and/or parallel to the front plate of the plug-in module. A projection is preferably formed at the installation and withdrawal handle and can be introduced through an opening in the front plate of the plug-in module and is shaped such that it can be latched in the front plate in the inwardly pivoted state of the installation and withdrawal handle by displacement, in particular by displacement in the longitudinal direction of the installation and withdrawal handle, for example in a direction perpendicular to the direction of the axis of rotation and/or parallel to the front plate.

The invention further includes a plug-in module having at least one installation and withdrawal apparatus in accordance with the aforesaid description and/or having an installation and withdrawal handle in accordance with the aforesaid description and a module holder having at least one such plug-in module.

The installation and withdrawal apparatus in accordance with the invention has the advantage that the installation and withdrawal handle is held by the holding apparatus in both the outwardly pivoted position and the inwardly pivoted position such that an unintentional inward or outward pivoting of the installation and withdrawal handle is avoided. If a corresponding spring element is used as the holding element, its spring force has the effect that the installation and withdrawal handle is pivoted into the outwardly pivoted position as soon as the plug-in module is pulled out of the module holder. The holding element is advantageously made as a spring element with a dual function which holds the installation and withdrawal handle in the outwardly pivoted state, when the plug-in module is pulled out, and in the latched in state, when the plug-in module is inserted. The arrangement of the holding element in the region of the guide element additionally permits a simple and space-saving design of the holding element. Since the installation and withdrawal handle can be latched directly to the front plate in the inwardly pivoted state, a separate latching element is superfluous so that the installation and withdrawal handle can be made in one part. The manufacturing costs can be lowered with respect to conventional installation and withdrawal apparatuses by the lower number of components of the installation and withdrawal apparatus in accordance with the invention. A further advantage of the installation and withdrawal apparatus in accordance with the invention is the simple operation thereof. Only the resistance of the holding apparatus has to be overcome for the inward pivoting of the installation and withdrawing handle.

Further advantageous embodiments result from the dependent claims and from the drawing.

The invention will be explained in more detail in the following with reference to the embodiment and to the drawing. There are shown:

FIG. 1 an oblique view of a section of a plug-in module with an embodiment of an installation and withdrawal apparatus in accordance with the present invention;

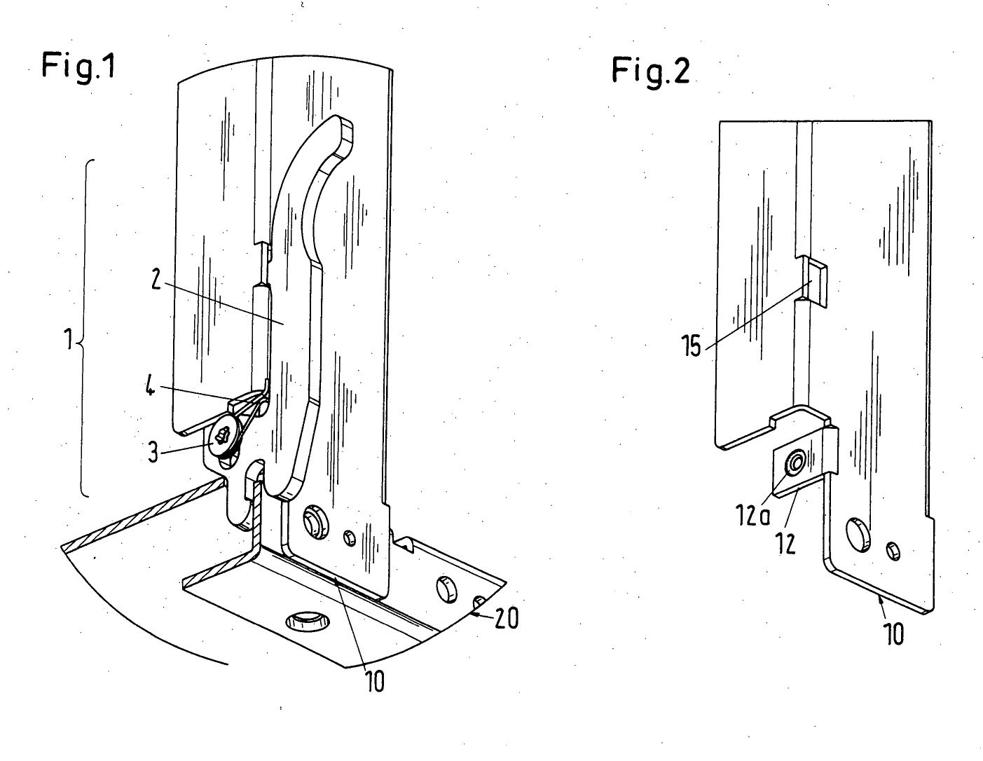

FIG. 2 an oblique view of an embodiment variant of a front structure with respect to the plug-in module shown in FIG. 1;

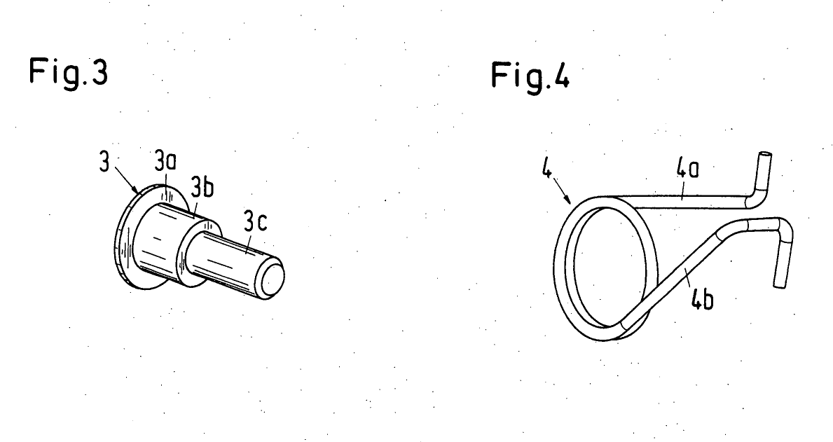

FIG. 3 an oblique view of an embodiment variant of a fitted collar screw with respect to the embodiment shown in FIG. 1;

FIG. 4 an oblique view of an embodiment variant of a leg spring with respect to the embodiment shown in FIG. 1;

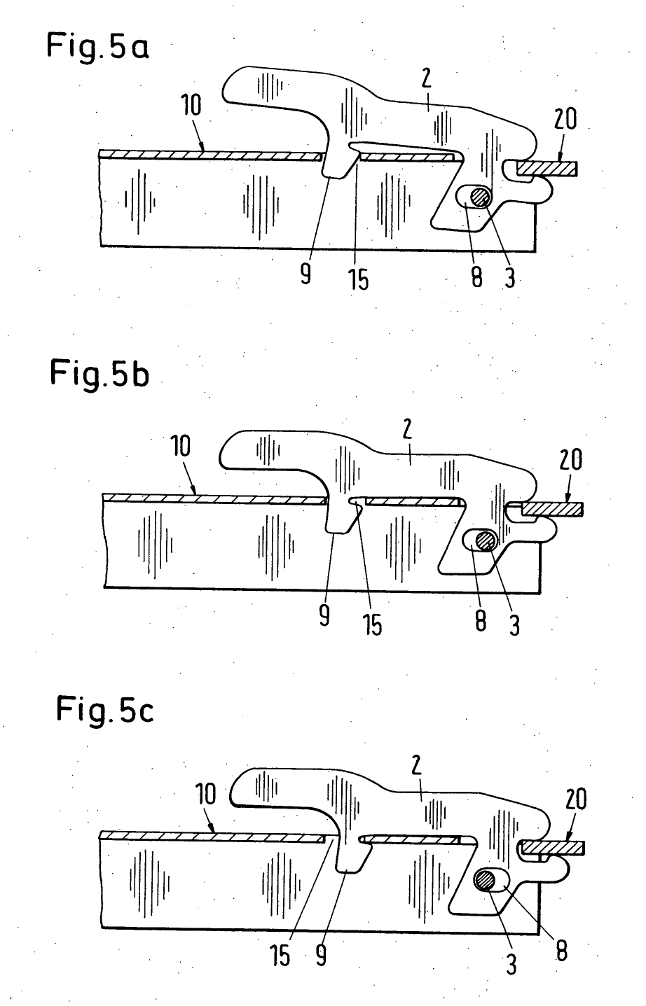

FIGS. 5a-c a longitudinal section through a section of a plug-in module having an installation and withdrawal apparatus in accordance with the embodiment and with the installation and withdrawal handle in three different positions;

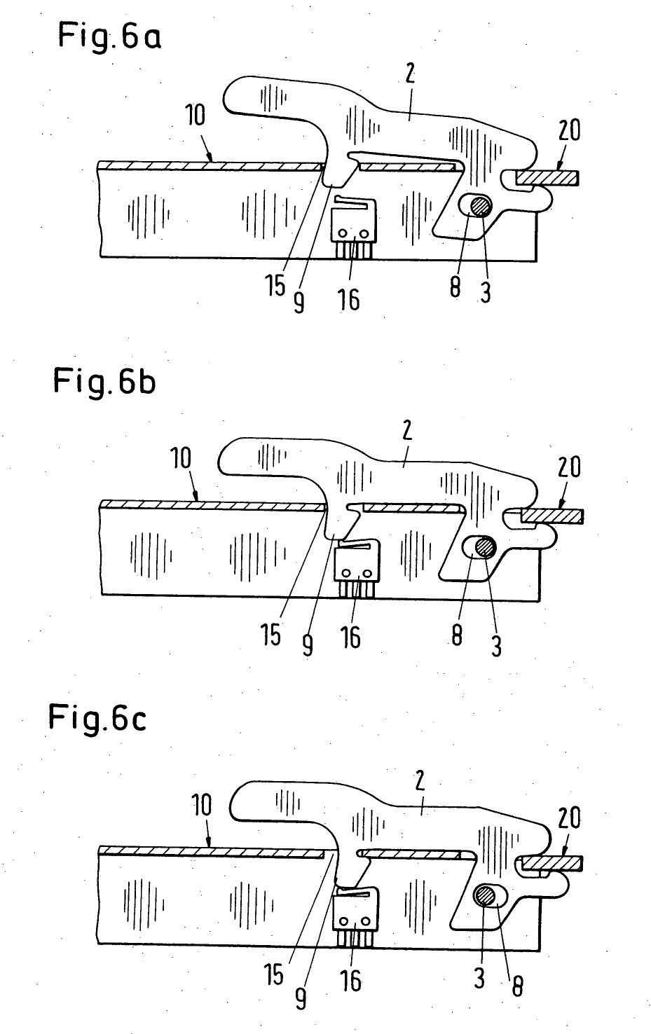

FIGS. 6a-c a longitudinal section through the section of a plug-in module shown in FIGS. 5a-c with the installation and withdrawal handle in three different positions and with a switch element for the active/passive switching of the plug-in module; and

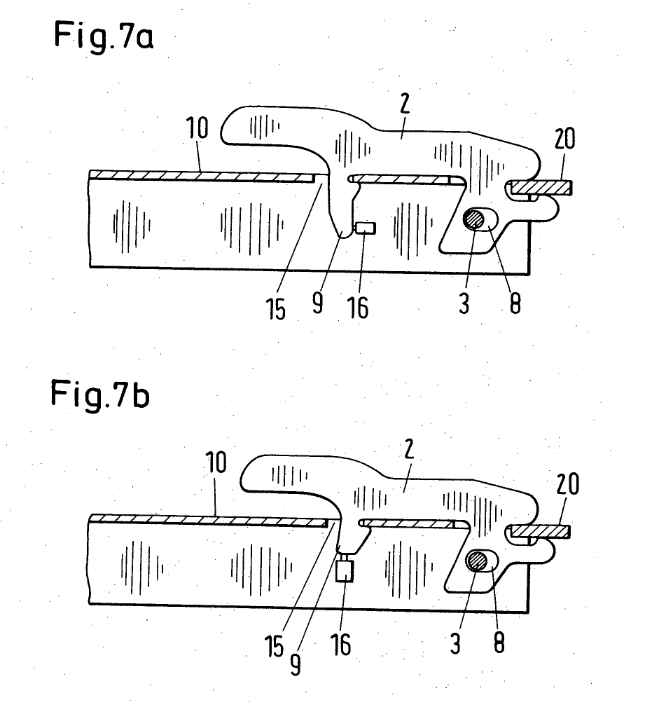

FIGS. 7a, b the section of FIG. 6 with two arrangement variants of the switch element.

FIG. 1 shows an oblique view of a section of a plug-in module with an embodiment of an installation and withdrawal apparatus 1 in accordance with the present invention. The installation and withdrawal apparatus includes an installation and withdrawal handle 2 and a guide element 3 about which the installation and withdrawal handle is rotatable and at which it is displaceably guided, for example in a direction perpendicular to the axis of rotation. The installation and withdrawal handle 2 is advantageously displaceably guided in its longitudinal direction. The guide element 3 can, for example, be made as a fitted collar screw or as a screw with a sleeve. The installation and withdrawal apparatus 1 further includes a holding apparatus having at least one holding element 4 which is formed as a leg spring in the embodiment shown in FIG. 1, said leg spring being arranged in the region of the guide element 3 and surrounding it, for example.

Furthermore, in the section shown in FIG. 1, a front structure 10 of a plug-in module is shown as well as a front structure 20 of a module holder into which the plug-in module has been inserted. The installation and withdrawal apparatus 1 is secured to the plug-in module in the lower region of the front structure 10 thereof such that the associated installation and withdrawal handle 2 can be outwardly pivoted forwardly and, in the inwardly pivoted position thereof, the front structure 20 of the module holder engages into a depression of the installation and withdrawal handle. On the outward pivoting of the installation and withdrawal handle 2, it is supported at the front structure 20 of the module holder, whereby the plug-in module is pulled out of the module holder. Conversely, the plug-in module can be inserted into the module holder in a corresponding manner by inwardly pivoting the installation and withdrawal handle 2 on the insertion of the plug-in module.

In an advantageous embodiment variant, the installation and withdrawal apparatus 1 additionally includes a holding apparatus having at least one holding element 4 to hold the installation and withdrawal handle 2 in an inwardly pivoted position, in particular in a latched in position, when the plug-in module is inserted. In a further advantageous embodiment variant, the installation and withdrawal apparatus 1 includes a holding apparatus having at least one holding element 4 to hold the installation and withdrawal handle 2 in an outwardly pivoted position to facilitate the insertion of the plug-in module. The holding element is, as shown in FIG. 1, advantageously made as a spring element with a dual function which holds the installation and withdrawal handle in the outwardly pivoted state, when the plug-in module is pulled out, and in the latched in stated, when the plug-in module is inserted.

FIG. 2 shows an oblique view of a preferred embodiment variant of a front structure with respect to the plug-in module shown in FIG. 1. The front structure 10 in this embodiment variant includes a securing part 12 which is connected to the front structure and serves for the securing of a guide element, for example of a fitted collar screw, of the installation and withdrawal apparatus described above. The securing part 12 can be made, for example, as a latched tab of the front structure 10. The securing part advantageously has an opening 12a, e.g. an opening with a collar or a pressed-in sleeve, into which the guide element of the installation and withdrawal apparatus described above can be inserted, pressed or screwed. The front structure is advantageously provided with an opening 15 to accept a projection formed at the installation and withdrawal handle of the installation and withdrawal apparatus described above.

FIG. 3 shows an embodiment variant of a guide element with respect to the embodiment shown in FIG. 1. In this embodiment variant, the guide element is made as a fitted collar screw which includes a screw head 3a, a shoulder 3b and a threaded part 3c which are expediently arranged coaxially in a row, with the screw head having the largest diameter, the shoulder having a middle diameter and the threaded part having the smallest diameter. The shoulder is advantageously made to receive the holding element so that a holding element such as a spring, can be arranged on the shoulder in addition to the installation and withdrawal handle. The guide element, i.e. the fitted collar screw, is advantageously designed such that a printed circuit board of the plug-in module can be fastened to the securing part by means thereof, for example in that the printed circuit board is pressed onto the securing part by means of the shoulder 3b. In a preferred embodiment variant, the turn of a leg spring and/or the installation and withdrawal handle are arranged on the shoulder and the width of the shoulder is dimensioned such that the installation and withdrawal handle can be outwardly pivoted by means of the helical spring. A screw with a sleeve can also e.g. be used as the guide element instead of the fitted collar screw.

FIG. 4 shows an embodiment variant of a holding element with respect to the embodiment shown in FIG. 1. The holding element 4 is made as a leg spring which preferably includes at least one turn of a helical spring and two legs 4a, 4b which can be bent or turned at their outer end. In the embodiment of FIG. 1, the turned end of the one leg is anchored to the lever 2, while the bent end of the other leg is supported at the front structure 10 of the plug-in module.

In FIGS. 5a-c, a longitudinal section is shown through a section of a plug-in module having an installation and withdrawal apparatus in accordance with the embodiment. The Figures show the installation and withdrawal handle 2 in three different positions during the inward pivoting and the latching in. A projection 9 is formed at the installation and withdrawal handle 2 in the embodiment shown and it can be introduced through an opening 15 of the front plate 10 of the plug-in module, when the installation and withdrawal handle is inwardly pivoted. Furthermore, a guide opening 8 of elongate shape, for example an elongate hole, is provided at the installation and withdrawal handle 2 in the embodiment shown and cooperates with a guide element 3 of the installation and withdrawal apparatus engaging into the guide opening. The longitudinal direction of the guide opening advantageously extends substantially parallel to the longitudinal direction of the installation and withdrawal handle 2 so that the installation and withdrawal handle 2 is rotatable about the guide element 3 and is guided in the longitudinal direction at the guide element. An end region of the installation and withdrawal handle 2 is made such that the installation and withdrawal handle is supported at a section 20 of the assembly carrier on the inward and outward pivoting, in order to facilitate the insertion and removal of the plug-in module.

FIG. 5a shows the installation and withdrawal handle 2 while being inwardly pivoted. Part of the projection 9 of the installation and withdrawal handle is already introduced into the opening 15 of the front plate 10. In this process, the installation and withdrawal handle 2 in FIG. 5a is displaced in the longitudinal direction into an introduction position, which can be achieved, for example, by means of a corresponding chamfer at the projection 9. The holding apparatus not shown in the image advantageously works against both the inward pivoting of the installation and withdrawal handle and its displacement in the longitudinal direction into the introduction position.

FIG. 5b shows the installation and withdrawal handle 2 after being inwardly pivoted. The projection 9 of the installation and withdrawal handle is completely introduced into the opening 15 of the front plate 10, with the installation and withdrawal handle 2 being shown in the introduction position in FIG. 5b. The holding apparatus not shown in the image advantageously works such that the installation and withdrawal handle 2 is displaced into a latch in position shown in FIG. 5c on being released in the longitudinal direction from the introduction position. The installation and removal handle then only needs to be completely inwardly pivoted, whereupon the installation and withdrawal handle is automatically latched in by the holding apparatus. The projection 9 can be provided, for example, with a latch-in contour which can be latched in the front structure 10 of the plug-in module. In the latched in position, the installation and withdrawal handle 2 is protected against unintentional outward pivoting and the plug-in module is secured against being pulled out and/or being slid out.

To outwardly pivot the installation and withdrawal handle 2, it is first displaced in the longitudinal direction into the introduction position and subsequently outwardly pivoted. The displacement in the introduction position advantageously takes place against the resistance of the holding apparatus, whereas the subsequent outward pivoting can be supported by the holding apparatus. In a further advantageous embodiment, the installation and withdrawal handle is held in the outwardly pivoted position by the holding apparatus.

FIGS. 6a-c show a longitudinal section through the section of a plug-in module shown in FIGS. 5a-c with an additional switch element 16 for the active/passive switching of the plug-in module. The switch element is arranged such that the projection 9 of the installation and withdrawal handle 2 actuates the switch element 16 as soon as the installation and withdrawal handle reaches the inwardly pivoted end position and the projection has been introduced into the opening 15 of the front plate 10 of the plug-in module. The switch state is independent of the longitudinal displacement of the installation and withdrawal handle in the embodiment shown, i.e. the switch state is the same both in the introduction position (see FIG. 6b) and in the latch in position (see FIG. 6c). The switch element 16 can be made, for example, as a microswitch and be used e.g. to activate a function in the plug-in module, e.g. a display element which shows that the plug-in module is completely inserted.

FIGS. 7a and b show two embodiments of the switch element 16 with respect to the section shown in FIG. 6c. The switch element in FIG. 7a is arranged such that it is only actuated in the latch in position of the installation and withdrawal handle 2, i.e. the corresponding function or the corresponding functions are only activated when the installation and withdrawal handle is latched in. FIG. 7b shows an alternative embodiment of the switch element 16 in which the switching state, as in the embodiment shown in FIGS. 6a-c, is independent of the longitudinal displacement of the installation and withdrawal handle, i.e. the corresponding function or functions are activated as soon as the installation and withdrawal handle has reached the inwardly pivoted position.

The design of the installation and withdrawal apparatus with an installation and withdrawal handle which is both rotatable about a guide element and displaceable in one direction permits a simple and cost-favorable structure with few components. The holding element is advantageously arranged in the region of the guide element and is designed as a spring element with a dual function which holds the installation and withdrawal handle in the outwardly pivoted state, when the plug-in module is pulled out, and in the latched in stated, when the plug-in module is inserted. The circumstance that the guide element can simultaneously satisfy a plurality of functions, e.g. as a bearing and guide part for the installation and withdrawal handle, as a securing element for a printed circuit board or as a securing part for the holding apparatus, also has a cost-reducing effect. A further advantage of the installation and withdrawal apparatus in accordance with the invention is the simple operation thereof in that only the resistance of the holding apparatus has to be overcome to inwardly pivot the installation and withdrawal handle and the installation and withdrawal handle automatically latches in the inwardly pivoted position. The installation and withdrawal handle must only be unlatched for the outward pivoting.

1. An installation and withdrawal apparatus for the plugging in and pulling out of a plug-in module into or out of a module holder, which installation and withdrawal apparatus (1) includes an installation and withdrawal handle (2) and at least one guide element (3) about which the installation and withdrawal handle is rotatable, characterized in that the installation and withdrawal handle (2) is additionally displaceable in one direction, in particular in a direction perpendicular to an axis of the rotary movement.

2. An installation and withdrawal apparatus in accordance with claim 1, wherein the installation and withdrawal handle (2) is displaceably guided in its longitudinal direction.

3. An installation and withdrawal apparatus in accordance with claim 1, wherein the guide element (3) is made as a fitted collar screw having a shoulder (3b) or as a screw with a sleeve.

4. An installation and withdrawal apparatus in accordance with claim 1 including a holding apparatus having at least one holding element (4) in order to hold the installation and withdrawal handle (2) in a position suitable for the insertion of the plug-in module and/or to hold the installation and withdrawal handle (2) in a latched in position in the inwardly pivoted state.

5. An installation and withdrawal apparatus in accordance with claim 4, wherein the holding element (4) is made as a spring, in particular as a leg spring which is operatively engaged with the installation and withdrawal handle (2) such that the spring is active in the direction of rotation and/or in the direction of displacement.

6. An installation and withdrawal apparatus in accordance with claim 1, wherein the holding element (4) is arranged in the region of the guide element (3), in particular at or on the guide element.

7. An installation and withdrawal apparatus in accordance with claim 1, wherein a switch element (16) for an active/passive switching of the plug-in module is provided which switch element (16) can be actuated by means of the installation and withdrawal handle (2), in particular by means of a projection (9) formed at the installation and withdrawal handle (2).

8. An installation and withdrawal handle for use in an installation and withdrawal apparatus in accordance with claim 1, characterized in that a guide opening (8) is formed in the installation and withdrawal handle (2) such that the installation and withdrawal handle (2) is both rotatable about a guide element and displaceable thereat.

9. An installation and withdrawal handle in accordance with claim 8, wherein the guide opening (8) is elongate in shape and is in particular made as an elongate hole.

10. An installation and withdrawal handle in accordance with claim 8, characterized in that the installation and withdrawal handle is made in one piece.

11. An installation and withdrawal handle in accordance with claim 8, which is latchable in a front plate (10) of the plug-in module in the inwardly pivoted state by displacement, in particular by displacement in its longitudinal direction.

12. An installation and withdrawal handle in accordance with claim 8, at which a projection (9) is formed, which projection can be introduced through an opening (15) of a front plate (10) of the plug-in module and which projection is shaped such that it can be latched in the front plate in the inwardly pivoted state of the installation and withdrawal handle (2) by displacement, in particular by displacement in the longitudinal direction of the installation and withdrawal handle.

13. A plug-in module including at least one installation and withdrawal apparatus in accordance with claim 1.

14. A module holder including at least one plug-in module in accordance with claim 13.

15. A plug-in module in accordance with claim 8 including at least one installation and withdrawal handle.

16. A module holder including at least one plug-in module in accordance with claim 15.
